(19) United States
(12) Patent Application Publication
(10) Pub. No.: US 2003/0176930 A1
(43) Pub. Date: Sep. 18, 2003

(54) Method and apparatus for generating an operating view for a building management system

(76) Inventor: Heinrich Nold, Ennenda (CH)

Correspondence Address: Harold C. Moore, Maginot, Moore & Bowman, Bank One Center/Tower, 111 Monument Circle, Suite 3000, Indianapolis, IN, 46204-5115, US

(21) Appl. No.: 10/383,151

(22) Filed: Mar. 6, 2003

(30) Foreign Application Priority Data
Mar. 14, 2002 (EP) 02005794.9

(51) Int. Cl. G05B 11/01; G05B 15/00; G05B 19/00

(52) U.S. Cl. 700/17; 700/11; 700/83; 700/264

(57) ABSTRACT

In a method of generating an operating view for a building management system a selectable background image is represented at an input/output terminal (38) by a client server system (4, 5). Data points of the building management system, which can be selected in a window representation, can be freely placed in the background image for example by a drag-and-drop operation, in which case a file (32) describing the operating view is generated by the client server system (4, 5). The current state or value of the data point represented in the operating view is automatically read by the client server system (4, 5) and optically represented in the operating view represented at the input/terminal (38).

The invention relates to a method of generating an operating view for a building management system and an apparatus for carrying out the method, as set forth in the features of claims 1 and 4.

Such methods and apparatuses are suitable for example for monitoring and operating an operational-technical installation of a building. The proposed method and the proposed apparatus are advantageously functions and parts respectively of an arrangement for controlling and/or regulating process parameters in complex technical systems, in which respect reference may be made by way of example to heating, ventilation and air conditioning installations, access and fire monitoring systems or, in general terms, building automation installations—which are also referred to as building management systems—and in which in particular also room air conditioning parameters are influenced. In a building automation installation, generally a plurality of so-called field devices such as sensors and actuators have to be monitored and operated.

In principle individual buildings or a plurality of buildings or groups of buildings can be operated and monitored with a building automation installation. In general a plurality of graphical user interfaces are available to building automation installations, the user interfaces representing for example an installation layout or the floor plan of a building or a storey with installed field devices. A graphical user interface for a building management system is also known for example from EP 678 204 A.

Now however the operating views which are available as standard in the building automation installation are too comprehensive or indeed unsuitable for certain monitoring tasks. It is therefore advantageous if service personnel can generate according to respective competence and instructions suitable operating views—which are so-to-speak tailor-made directly with the building automation installation.

The object of the invention is to propose a method with which a suitable graphical user interface for a building management system is generated, and also to provide an apparatus with which the method can be carried into effect.

In accordance with the invention the specified object is attained by the features of claims 1 and 4. Advantageous configurations are set forth in the appendant claims.

Embodiments of the invention are described in greater detail hereinafter with reference to the drawing in which:

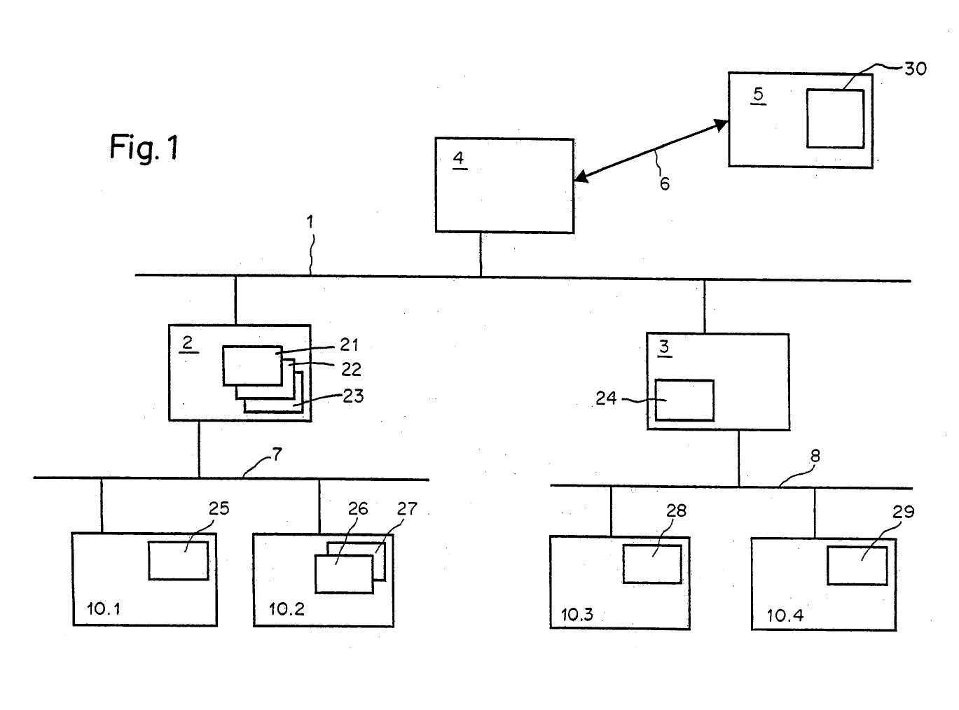

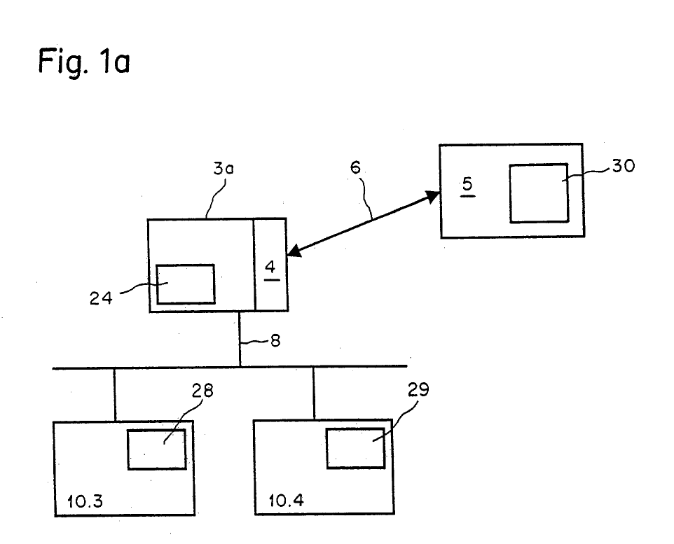

FIG. 1 shows the structure in principle of an arrangement having an operating view for monitoring, controlling and/or regulating an operational-technical installation of a building,

FIG. 1a shows a variant of the arrangement,

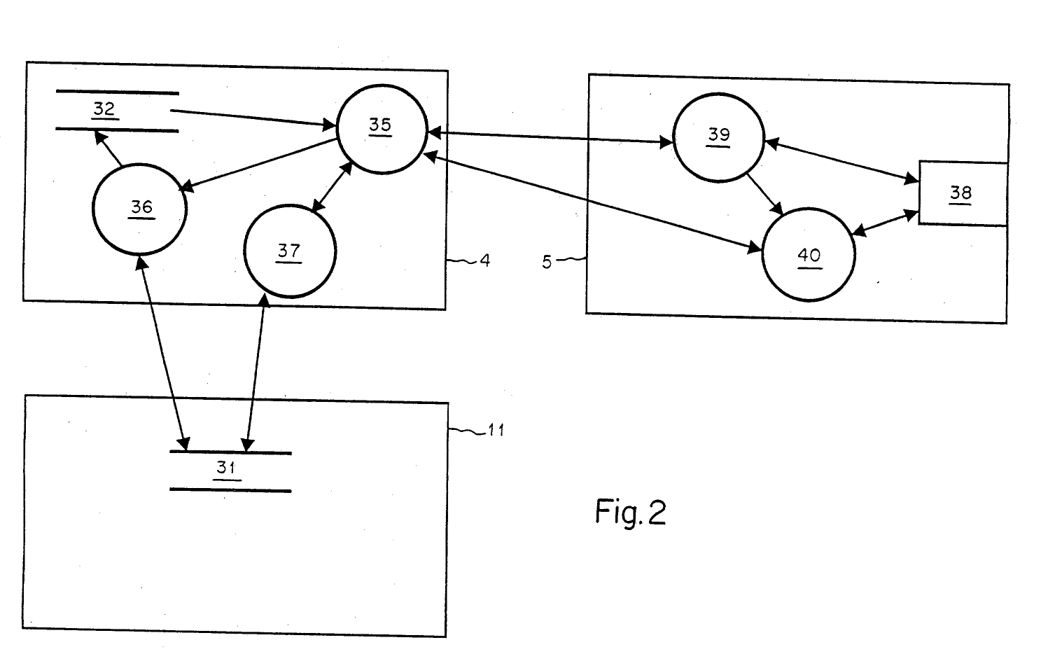

FIG. 2 shows a data flow chart relating to generation and use of a new operating view of the operational-technical installation,

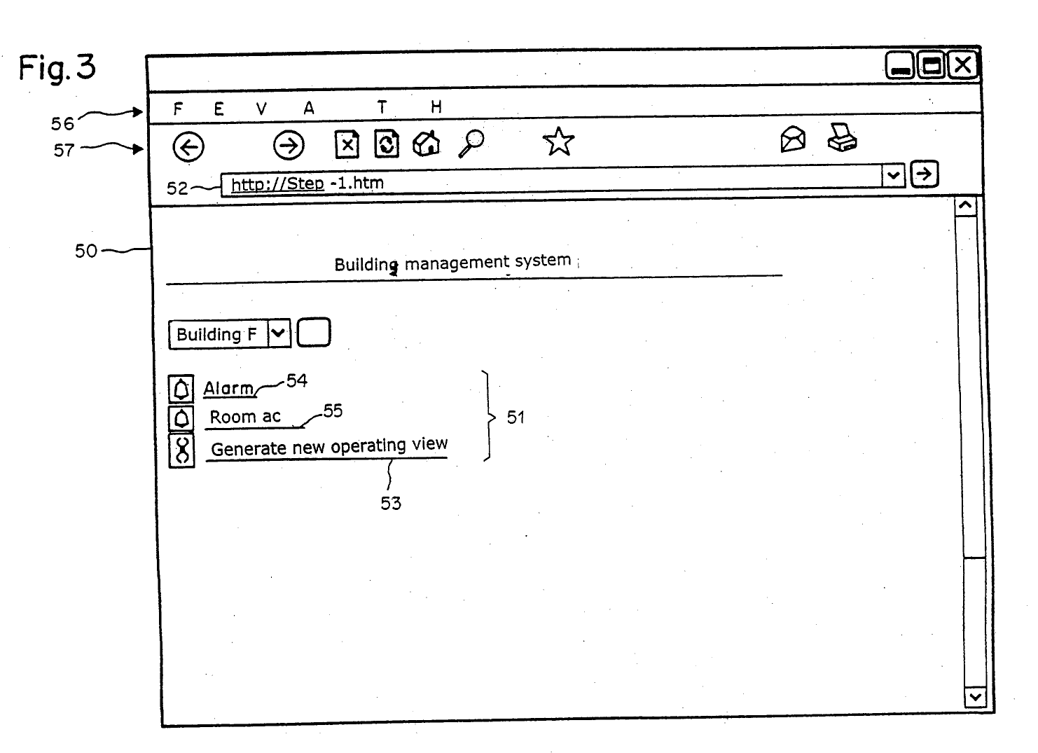

FIG. 3 shows a first window representation to explain method steps, in particular a first method step for the generation of the new operating view,

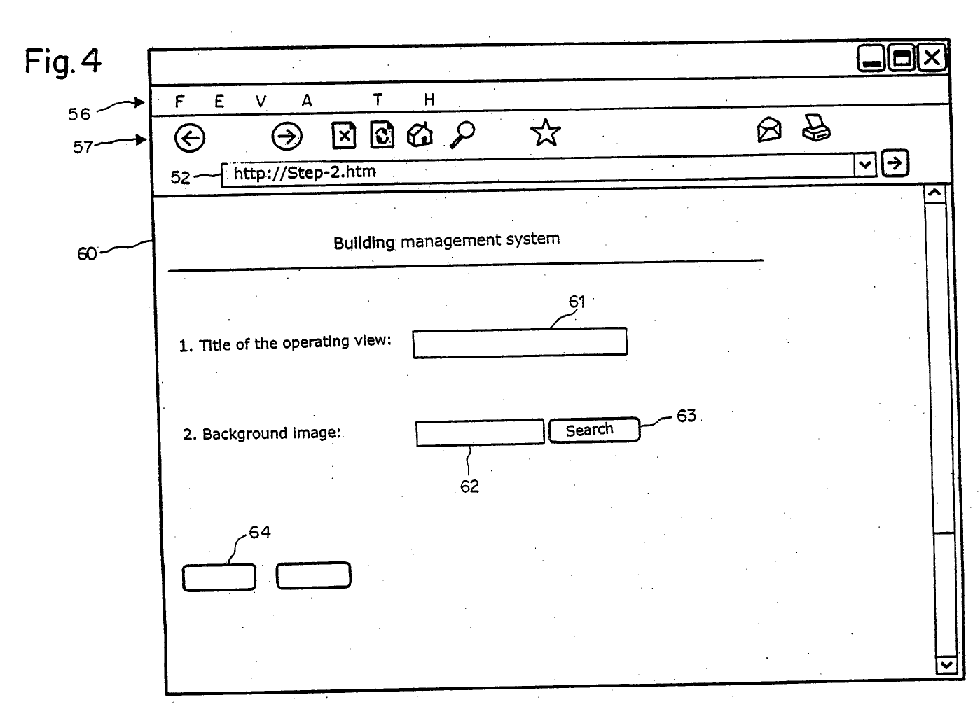

FIG. 4 shows a second window representation to explain method steps, in particular a second method step for the generation of the operating view,

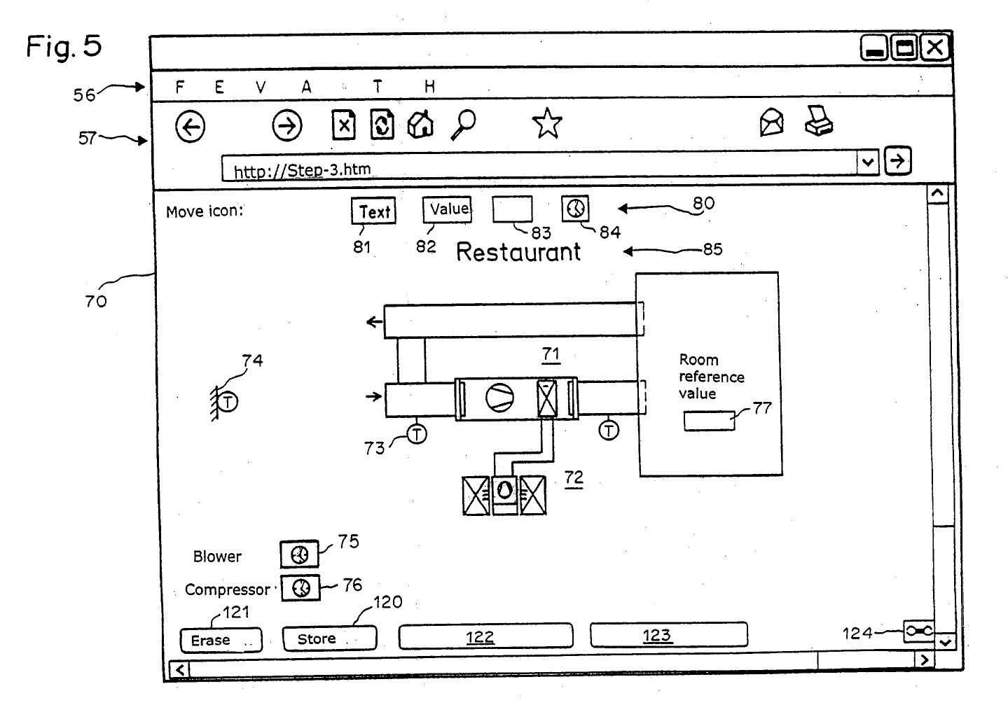

FIG. 5 shows a third window representation to explain method steps, in particular a third method step for the generation of the operating view,

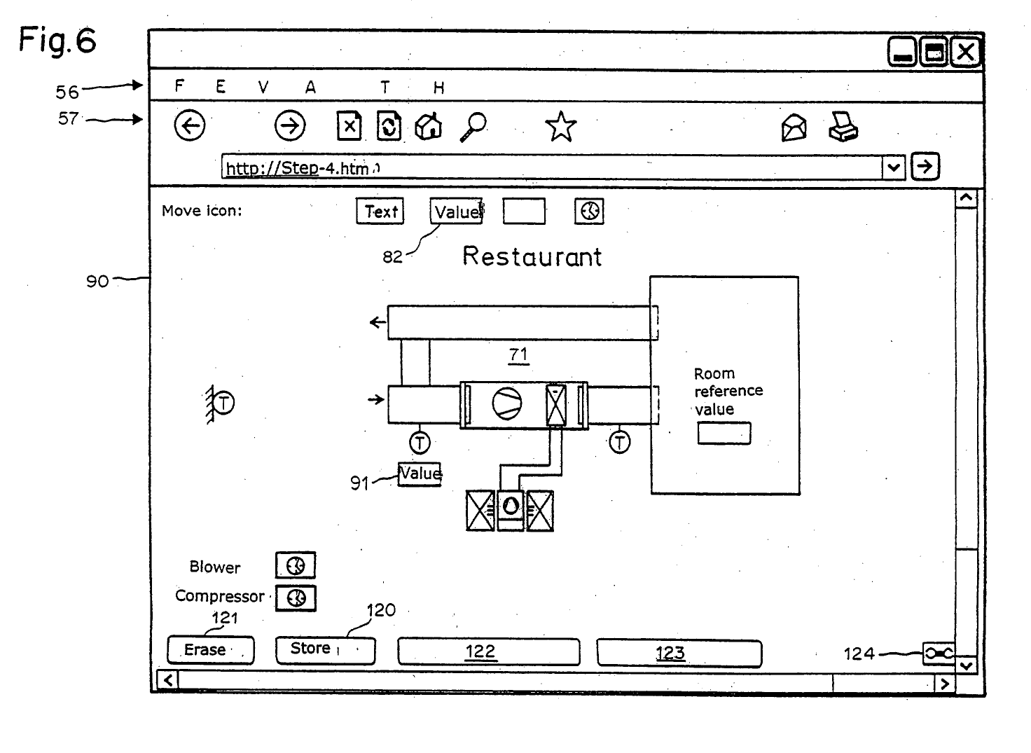

FIG. 6 shows a fourth window representation to explain method steps, in particular the third method step for the generation of the operating view,

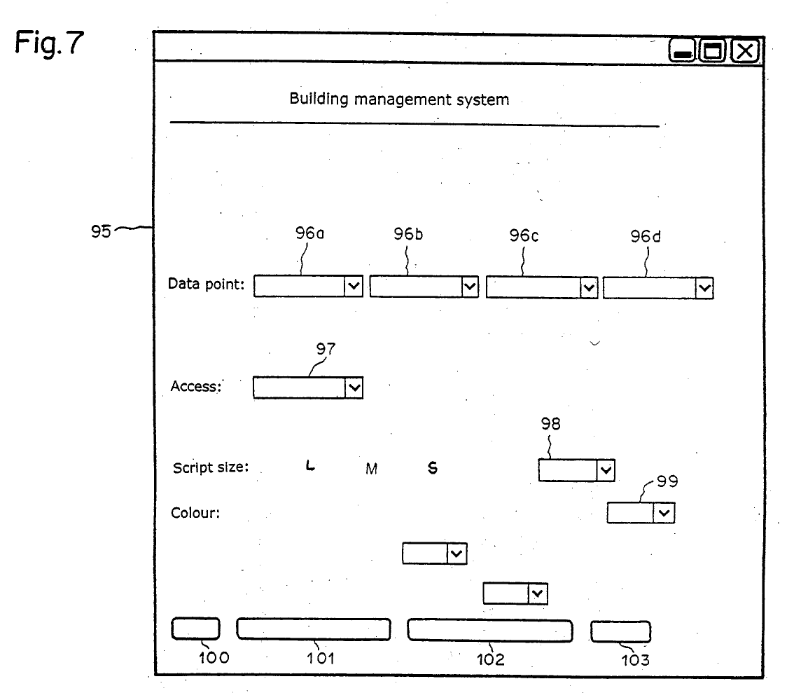

FIG. 7 shows a fifth window representation to explain method steps, in particular a fourth method step for the generation of the operating view, and

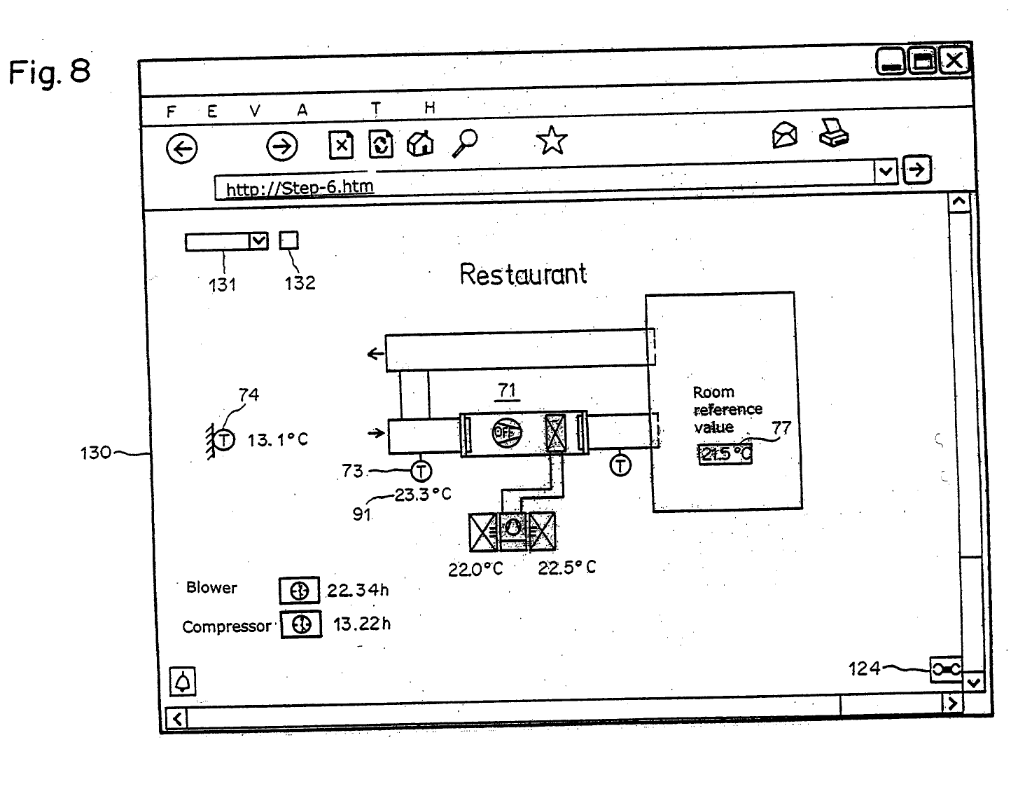

FIG. 8 shows a sixth window representation with the operating view by way of example according to the invention.

In FIG. 1 reference 1 denotes a communication arrangement for connecting units 2, 3 and 4 of an arrangement for monitoring, controlling and/or regulating an operation-technical installation for one or more buildings.

It will be self-apparent that the example illustrated here only shows units which are necessary to describe the invention in its surroundings and an actual arrangement for monitoring, control and/or regulating an operational-technical installation generally has still further units. The structure of the real arrangement can certainly also be hierarchically more deeply or less deeply nested, in other words, one level of control units in turn can be controlled by a higher-order control unit and a plurality of levels can exist. Data relating to the structure of the installation and addresses of components are not necessarily stored centrally but can be stored in a plurality of server devices which are arranged distributedly in the networks.

The communication arrangement 1 is basically a private or public data communication network which is suitable for data exchange between individual units of the operational-technical installation.

Bus systems and technologies or standards which can be used for implementation of the communication arrangement 1 are for example Ethernet from Xerox, LON or LonWorks® from ECHELON, the European Installation Bus EIB or the PROFIBUS defined in accordance with German standard DIN 19245. In principle instead of the bus system or supplemental thereto it is also possible to use optical data communication channels or a radio network, for example a glass fibre network or a cellular telephone network such as for example GSM or UMTS. If necessary the operational-technical installation is also connected to the Internet.

By way of example a first unit 2 and a second unit 3 are each a regulating and/or control device. A third unit is a server device 4. A client device 5 is connected to the server device 4 by way of a communication channel 6.

Typically, the regulating and/or control devices 2 and 3 are connected to field devices 10 by way of further communication arrangements 7 or 8.

A field device 10 is typically a sensor or an actuator or also a combination of a sensor and an actuator.

By way of example the first unit 2 of the regulating and/or control device is connected by way of a first local communication arrangement 7 to a temperature sensor 10.1 and a valve drive 10.2 while the second unit 3 of the regulating and/or control device is connected by way of a second local communication arrangement 8 to a moisture sensor 10.3 and a flap drive 10.4.

Operational-technical installations have a plurality of so-called data points. Data points are addressable information units to which data signals are outputted or from data signals are read. A device or a functional unit of a device can be represented for other functional units—for example an operating unit or a control station—by at least one data point. This means that the device or the functional unit of the device—for example from a control station or a server device—can be addressed or also controlled by way of its data point or points. In software terms a data point is a variable which can be simple or structured, from the point of view of its data type.

In the illustrated example of the installation the first unit 2 of the regulating and/or control device has a first data point 21, a second data point 22 and a third data point 23 while the second unit 3 has a fourth data point 24. The temperature sensor 10.1 also has a fifth data point 25, the valve drive 10.2 has a sixth data point 26 and a seventh data point 27, the moisture sensor 10.3 has an eighth data point 28 and finally the flap drive 10.4 has a ninth data point 29.

The client device 5 and the server device 4 together form a so-called client server system in which the client device 5 is responsible in particular for the representation of an operating view 30 while the server device 4 substantially prepares the data for the operating view 30.

The operating view 30 is a graphical user interface which is advantageously described in a file stored in the server device 4. An advantageous implementation of the invention can be achieved if the operating view 30 is described by a file written in HTML (HyperText Markup Language), wherein the file generally has cross-references to other files—advantageously stored in the server device—which in turn have HTML code or JavaScript or also a Java applet.

The file which is stored in the server device 5 and with which the new operating view is established does not necessarily have to be an HTML document; HTML is at the present time only the description language for representing graphics pages by means of logic markings which can preferably be used for standardised web browser programs. In principle it would also be possible to use another language for describing the operating view. It is however an essential advantage of the invention that the operating view can be represented with a well-known interpretation program, namely a generally known web browser program.

The client device 5 is typically a so-called web client or world wide web client, that is to say a hardware platform with a runable web browser program, a data interface, a graphical display and input means.

Preferably the client device 5 is implemented by an inexpensive personal computer, a so-called notebook or handheld, for example a SIMpad from Siemens or a M500 from Palm. The interpretation activity 39 is advantageously a so-called web browser program which executes documents written in HTML (HyperText Markup Language) and reproduces same on the input/output terminal 38.

The server device 4 is a computer which typically manages without its own user terminal and which is advantageously implemented in the form of a so-called embedded device.

In principle the server device 4 and the client device 5 however could also be implemented in a single computer. The communication channel 6 is a wired or wireless connection. In an advantageous embodiment the communication channel 6 is a so-called Bluetooth connection or the combination of a Bluetooth connection between the client device 5 and a mobile telephone and a GSM connection between the mobile telephone and the server device 4.

The client server system 4 and 5 can certainly also be used in very simple operational-technical installations and can also be implemented for example in operational-technical installations without a data network.

FIG. 1a shows a simple arrangement for the monitoring, control and/or regulation of an operational-technical installation of a building, with a variant 3a of the above-described regulating and/or control device 3. The described server device 4 is here for example provided in the variant 3a of the regulating and/or control device. The variant 3a is here therefore on the one hand a regulating and/or control device connected to the field devices 10.3 and 10.4 and on the other hand part of the client server system 4 and 5.

In the mode of representation for data flow charts which is selected for FIG. 2 and which is known from the literature (in that respect see for example D J Hatley, I A Pirbhai: Strategies for Real-Time System Specification, Dorset House, N.Y. 1988), a circle denotes an activity, a rectangle denotes an adjoining system or a sub-system and an arrow denotes a channel for the transmission of data and/or events, the tip of the arrow pointing in the substantial data flow direction. A data store which is available generally to a plurality of activities is represented by two parallel lines of equal length. The term data store is used here to denote a device for the storage of data, which also has means for preventing conflicts in the event of time-parallel access of a plurality of activities to the data. Moreover for example an arrangement comprising two activities connected by a channel is equivalent to a single activity which performs all functions of said two activities. An activity can generally be broken down into a plurality of activities connected by way of channels and/or data stores. Further terms used in the data flow chart literature are ‘terminator’ for the adjoining system or the sub-system, ‘process’ or ‘task’ for the activity, ‘data flow’ or ‘channel’ for the channel and ‘pool’ or ‘data pool’ for the data store.

An activity can be implemented in the form of an electronic circuit or also in software terms for example as a process, method, program portion or routine, in which respect activity in a software implementation also includes the target hardware.

In order to simplify the representation, the data flow chart in FIG. 2 includes an installation block which is identified by reference numeral 11 and which also combines the two units 2 and 3 of the regulating and/or control device and the field devices 10 and includes a first data store 31. The first data store 31 in FIG. 2 has the nine data points 21 to 29 shown in FIG. 1 and their description data as well as description data of the operational-technical installation. The description data of a data point advantageously include addresses, hierarchical information, data type and physical significance of the data point.

A second data store 32 is advantageously arranged in the server device 4 (FIG. 2). Data by which the actual structure and the mode of operation of the operating view 30 (FIG. 1 or FIG. 1a) is described are advantageously stored in the second data store 32. The server device 4 advantageously has a server activity 35, an engineering activity 36 and an access activity 37.

The client device 5 advantageously has an input/output terminal 38, an interpretation activity 39 and if necessary also a further engineering activity 40.

An advantageous description of the operating view 30 can be achieved by an HTML file which is stored in the second data store 32 and which is reproduced by way of the server activity 35 implemented by a standard HTTP (HyperText Transfer Protocol)-Server, by the interpretation activity 39 implemented in the form of a standard web browser, on the input/output terminal 38.

During a method of generating a new operating view 30 various window representations for a user dialogue are advantageously created by the engineering activity 40 and represented by way of the server activity 35 and the interpretation activity 39 on the input/output terminal 38.

The access activity 37 permits reading of the data points 21 to 29 and the description data thereof and also the description data of the operational-technical installation, and if need be variation in the data points 21 to 29.

FIG. 3 shows a first window representation 50 by way of example, which is visible on the input/output terminal and which preferably has a menu 51 for the selection of commands. The first window representation 50 results from the interpretation of a file which is advantageously written in HTML and the title or address of which is represented in an address line 52 and which is advantageously stored in the server device 4 in the second data store 32 (FIG. 2).

To generate a new operating view, in a first method step the engineering activity 36 (FIG. 2) is advantageously started by clicking on a first line 53 of the menu.

Operating views which have already been generated can be represented for example by clicking on further lines 54 or 55 of the menu. If necessary it is possible to use known standard functions of the web browser program used as the interpretation activity 39, from command lines 56 or 57.

After having clicked on the first line 53 of the menu a second window representation 60 by way of example (FIG. 4) becomes visible on the input/output terminal 38, which advantageously has a title field 61 for the input of a title identification for the new operating view and further a selection menu 62 for the selection of a background image for the new operating view. The background image is preferably stored in a file which can be clicked on in the selection menu 62, in the second data store 32 of the server device 4. The background image shows for example a part of the building automation installation or the floor plan of a building being monitored, but it can also be empty. In an advantageous embodiment it is also possible to select a search function 63, by way of which the background image can be searched in the server device 4.

In a second method step the operator selects the desired background image by way of the selection menu 62 or by way of the search function 63. Advantageously the engineering activity 36 of the server device 4, when clicking on a soft key 64, automatically produces a new file with the background image and its title identification, the new file advantageously being stored in the server device 4 in the second data store 32. The new file is advantageously a web page which is written in HTML and which, after clicking on the soft key 64, is automatically represented by the interpretation activity 39 on the input/output terminal. In an advantageous implementation the background image is preferably inserted into the new document by way of a cross-reference. The nature of the cross-reference is preferably such that the target file of the cross-reference is imported in such a way that the overall image is represented in a single window, which is also known by the expression ‘embedded document’. According to requirements speech constructs of various different programming or description languages which can be executed by the interpretation activity 39 are incorporated in the file describing the new operating view. By way of example reference is made here to constructs of JavaScript or Java, for example objects in JavaScript or so-called Java applets which are incorporated into an HTML document.

In further method steps the selected static background image is converted by the engineering activity 36 (FIG. 2) by means of elementary user inputs into a functional new operating view and for that purpose supplemented by way of example with text and symbols and linked with data points in such a way that current values and states of the interlinked data points—that is to say so-called dynamic information—can be meaningfully represented in the new operating view and in certain cases can also be varied by way of the new operating view.

An interpretation of the new file generated in the second method step is illustrated by way of example in a third window representation 70 by way of example (FIG. 5). The background image shows a diagram 71 of a heating, ventilation and air conditioning installation for a room, with an assembly 72, a duct temperature sensor 73, an outside temperature sensor 74, a first operating hours meter 75 for a blower, a second operating hours meter 76 for a compressor, and a display panel 77 for a room temperature reference value.

Advantageously objects with which the new operating view can be supplemented are represented in a selection region 80 of the third window representation 70 in the form of icons 81 to 84. Advantageously the title identification selected in the second method step is entered in a title region 85 of the third window representation 70.

The number and variants of the objects which are available for the method of generating a new operating view are selected in non-critical fashion in the illustrated example and can be matched within wide limits to actual requirements. It will be self-apparent that the objects do not necessarily have to be available in the form of icons but can be afforded differently, for example by way of a different menu technology. In an advantageous implementation by way of example the icons 81 to 84 can be selected with a cursor by clicking thereon and can then be freely positioned with the cursor in the operating view. In the present example a first icon 81 serves for placement of a piece of text and a second icon 82 serves for placement of a value which can be linked to a data point of the installation. Further icons 83 and 84 serve for example for representing a time or switching time or for producing a link to a certain switching time.

In a third method step a desired object is selected by way of example by suitable mouse clicking in the selection region and placed at the desired location in the diagram 71 by displacement of the object in a drag-and-drop operation. The engineering activity 40 of the client device 5 is advantageously used for executing the drag-and-drop operation.

FIG. 6 shows a fourth window representation 90 by way of example, after an additional object 91—more specifically a value—has been placed in the diagram 71, in the third method step.

At the end of the drag-and-drop operation, that is to say after placement of the object, a fifth—preferably additional—window 95 as shown in FIG. 7 is represented automatically on the input/output terminal 38 (FIG. 3), in which window in a fourth method step associated attributes—such as an associated data point address, pre-defined values or constants, mode of access, representation size or colour—are established in relation to the object placed in the third method step.

To establish the attributes the window 95 advantageously has selection fields 96a to 96d by which it is possible to select a desired data point from the quantity of data points 21 to 29 (FIG. 1) present in the installation. By structuring and labelling of the selection fields 96a to 96d the quantity of data points 21 to 29 present in the installations can be made available clearly for the operating personnel without detail knowledge, for example in relation to address allocation rules, being necessary.

By way of example the additional object 91 is linked to a data point by a procedure whereby in the fourth method step the service personnel searches for the desired duct temperature sensor 73 in the selection field 96 and clicks thereon, representing by way of example the fifth data point 25 (FIG. 1).

In a further selection field 97 the desired access mode—for example ‘read only’ or ‘read and modify’—can be set for the selected data point. The window 95 advantageously has additional selection fields 98 and 99 for example for establishing script sizes and script colour for the placed object.

The window 95 advantageously also has command lines or soft keys 100 to 103. For example a first soft key 100 serves to terminate the current action, a second soft key 101 serves to set pre-defined values or constants, a third soft key 102 serves to erase the currently processed object and a fourth soft key 103 serves to undo the current action.

After clicking on the first soft key 100, the object 91 is defined and the window 95 is closed therewith.

In general a sequence with the third method step and the fourth method step is implemented repeatedly until all desired objects are arranged in the background image, provided with the necessary attributes and thus if needed linked to the associated data point addresses.

When all desired objects are arranged in the background and provided with the necessary attributes and thus if necessary linked to the associated data point addresses of the installation, in a fifth method step, by activation of a soft key 120 available in the third and fourth window representations 70 and 90 respectively (FIG. 5 and FIG. 6 respectively), the code of the new operating view is automatically completed by the engineering activity 36 (FIG. 2) and at least one new file with the complete description of the new operating view is stored in the second data store 32 in the server device 4.

Further operating means 121 to 124 are advantageously available for selecting and triggering useful editing functions, in the third and fourth window representations 70 and 90 respectively (FIG. 5 and FIG. 6 respectively). For example the two operating views 70 and 90 have a first operating means 121 for erasing the current operating view, a second operating means 122 for the removal of all placed objects of the current operating view, a third operating means 123 for establishing a file name for the current operating view and a fourth operating means 124 for modifying the background image. The operating means 121 to 124 can be implemented for example by soft keys.

FIG. 8 shows a sixth window representation 130 by way of example, with the new file represented by the interpretation activity 39 (FIG. 2) on the input/output terminal 38, with the description of the new operating view which can be generated with the above-described five methods steps 1 to 5.

Entered in the new operating view are current values of process parameters which are automatically detected by the access activity 37 (FIG. 2) of the server device 4 in the installation block 11. The object 91 linked to the fifth data point 25 (FIG. 1) or the temperature sensor 10.1 shows the value 23.3° C. currently measured by the temperature sensor 10.1. The display field 77 associated for example with the first data point 21 in a repetition of the third and fourth method steps shows the room reference value for the regulating and/or control device 2 of 21.5° C. If necessary the room reference value shown in the display field 77 can be modified by the service personnel directly by way of the operating view, by suitably modifying the value in the display field 77. The operating view is advantageously programmed in such a way that to modify values the service personnel can use known procedures—such as for example selecting the field by clicking on it and then inputting the fresh value.

The sixth window representation 130 advantageously has a selection field 131 and an activation button 132 for selecting and starting further operating views which are already present. Activation of the operating means 124 goes back to the third method step, advantageously representing the fourth window representation 90 with which the method of generating the new operating view can be continued.

The fact that the server device 4 has items of current information in respect of the building management system, that is to say information about existing data points, the value or state thereof and information about the structure and the components of the installation, means that a userfriendly graphical user interface can be very easily generated directly with the installation by the combination of the engineering activity furnished by the server device 4 to the client device 5 and dynamic file generation of the server device 4. That provides that an operation which hitherto could be executed only by expensively trained personnel can now also be carried out without special knowledge.

1. A method of generating an operating view for a user interface of an apparatus for controlling and/or regulating process parameters, comprising
a control and/or regulating arrangement (2, 3, 7, 8, 10),
a server device (4), and
a client device (5) connected to the server device (4) by way of a communication channel (6),
wherein the server device (4) has a data store (32) and an activity (35; 36; 37), and
wherein the client device (5) has an activity (39; 40) and an input/output terminal (38) for the user interface (130), and
wherein the client device (5) and the server device (4) are designed and connected by way of the communication channel (6) in such a way that together they form a so-called client server system (5, 6, 4),
comprising
a method step in which a background image (71) can be selected by way of the client device (5) and represented at the input/output terminal (38),
a method step in which a data point (21, 22 to 29) of the control and/or regulating arrangement (2, 3, 7, 8, 10) is selectably represented at the input/output terminal (38) and inserted in the background image (71) represented at the input/output terminal (38), wherein by way of the server device (4) a description (31) readable by a computer of the current structure and the present data points (21 to 29) of the control and/or regulating arrangement (2, 3, 7, 8, 10) can be accessed and is available for the client device for reading,
a method step in which the client server system (5, 4, 6) generates a file (32) describing the operating view (130) from a data set describing the background image (71), wherein the operating view (130; 30) represents a data point (21 or 25 respectively) which is inserted in the background image (71) and selected by an operator, and
a method step in which the current state or value of the data point (21, 22 to 29) selected by the operator is automatically read by the client server system (5, 4, 6) and optically represented in the operating view (130; 30) represented at the input/output terminal (38).

2. A method according to claim 1 characterised by a method step in which the state or value of a data point (21, 22 to 29), which can be selected in the operating view (130; 30), of the control and/or regulating arrangement (2, 3, 7, 8, 10), can be modified by way of the operating view (130; 30).

3. A method according to a preceding claim characterised in that a selected data point (21, 22 to 29) is displaceable by drag-and-drop operation on the background image (71).

4. An arrangement for carrying out a method according to one of claims 1 to 3.

5. An arrangement according to claim 4 characterised in that the file (32) describing the operating view (30; 130) can be interpreted by a web browser program (39).
